(19) United States
(12) Patent Application Publication
(10) Pub. No.: US 2024/0149082 A1
(43) Pub. Date: May 9, 2024

(54) PERSONAL PROTECTIVE DEVICE AND FILTERING GROUP

(71) Applicant: INNOVATE ITALIA GROUP S.R.L., Bolzano (IT)

(72) Inventors: Fulvio BARBI, Bolzano (IT); Giuseppe Daniele ROTA, Bolzano (IT)

(21) Appl. No.: 18/549,093

(22) PCT Filed: Mar. 1, 2022
(86) PCT No.: PCT/IB2022/051780

§ 371 Date: Sep. 5, 2023

(30) Foreign Application Priority Data
Mar. 9, 2021 (IT) 102021000005435

(51) Int. Cl. A62B 23/02; A62B 18/08

(52) U.S. Cl. CPC A62B 23/02; A62B 18/08

(57) ABSTRACT

A wearable personal protective device has a protective wall of polymeric material and a central wall portion arranged in front of a user's nose when the personal protective device is worn. A first inlet opening, made in the protective wall, is suitable for allowing passage of an air flow into and out of the external environment. A filtering group arranged at the first inlet opening has a filtering medium for filtering an incoming air flow passing therethrough. The personal protective device has a deflector wall projecting from a central inner side of the central wall portion and extending over a certain depth from the central inner side towards the inner cavity of the personal protective device and along a sagittal direction incident on the central wall portion, the deflector wall being arranged so as to divert an exhaled air flow from the user's mouth and/or nose towards the first inlet opening.

The present invention relates, in general, to the field of personal protective device and in particular to wearable masks.

In particular, the present invention relates to a personal protective device and a filtering group for such a device.

Wearable personal protective devices for filtering or sanitizing respirable air are generally known, i.e., wearable masks equipped with filters designed to minimize the amount of volatile material, dust, pollutants, or pathogens—biological or otherwise—that reach the respiratory tract of the wearer through the mouth and/or nose.

Currently, users of personal protective device, whether professionals or individuals, have at their disposal:
medical devices (MD) (surgical masks—UNI EN 14683);
personal protective devices (PPD) of the full-face type, masks, half-masks, respirators and self-contained breathing apparatus, reusable or not, with different levels of protection—UNI EN 149, 140, 143, 1827-FFP1, FFP2, FFP3);
disposable or reusable devices;
devices with fixed or interchangeable filter;
simple devices (entirely made of filtering material) or complex ones (differentiated materials, with removable parts, exhalation/inhalation valves, and external filters, which may be integrated with each other).

In all the areas examined, especially in the workplace and with the advent of the recent COVID-19 pandemic, the masks mainly used are disposable paper masks with or without valves.

The world of disposable masks, whether PPD or MD, has a number of disadvantages ranging from the difficulty in finding the raw material, poor ergonomics and comfort of use, poor variability in size, poor recyclability of the material and the lack of an optimal system for fixing onto the face, which affects the effectiveness thereof.

There are certified reusable masks that have a durable plastic main body and interchangeable filter cartridges. This type of mask provides a better fit and ergonomics, an improved breathing chamber, and a choice of filter element.

However, the latter type of reusable masks comes with significant disadvantages. In effect, this type of mask is often cumbersome and envisages heavy filter cartridges which are complex and difficult to carry. Moreover, being totally opaque, said masks do not allow the person's face or lips to be viewed during the conversation.

Additionally, the types of reusable masks of the prior art suffer from the drawback of fogging the glasses worn by the user when the air flow escapes from the upper portions of the mask.

Moreover, even when the seal on the face is ensured, the reusable masks of the prior art suffer from the drawback of having the air in the inner chamber of the mask “spoiled” due to an incorrect circulation of the inhalation and exhalation flows.

Therefore, there is a strong need to propose a personal protection device and a filtering unit which are able to overcome the aforesaid drawbacks of the prior art, and in particular, which are able to ensure improved breathing and air flow circulation in the inner chamber of the protective device and at the same time improve the wearability and flexibility features of the devices of the prior art.

This requirement is satisfied by a personal protective device and filtering group according to the attached independent claims. The dependent claims describe preferred or advantageous embodiments.

The features and advantages of the personal protective device and of the filtering group will become apparent from the description below of its preferred embodiments, given by way of non-limiting example, with reference to the attached figures, wherein:

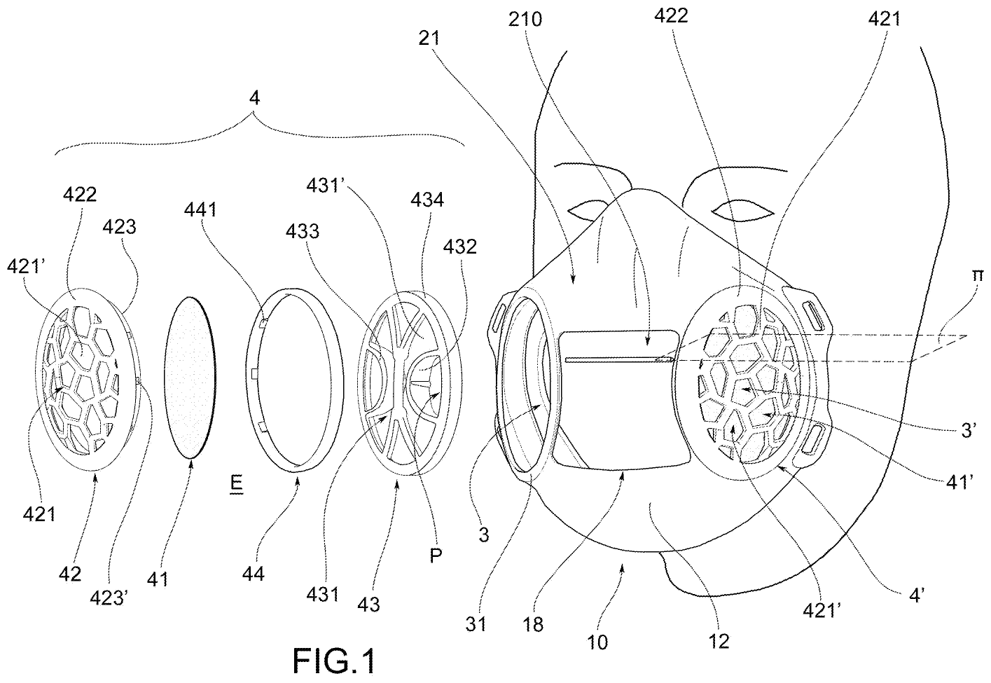

FIG. 1 shows an individual protective device according to an embodiment of the present invention in a worn configuration on a user, and wherein an exploded view of the filtering group (on one side of the personal protective device) and an installed view of the filtering group (on the other side of the personal protective device) according to an embodiment of the present invention are also shown;

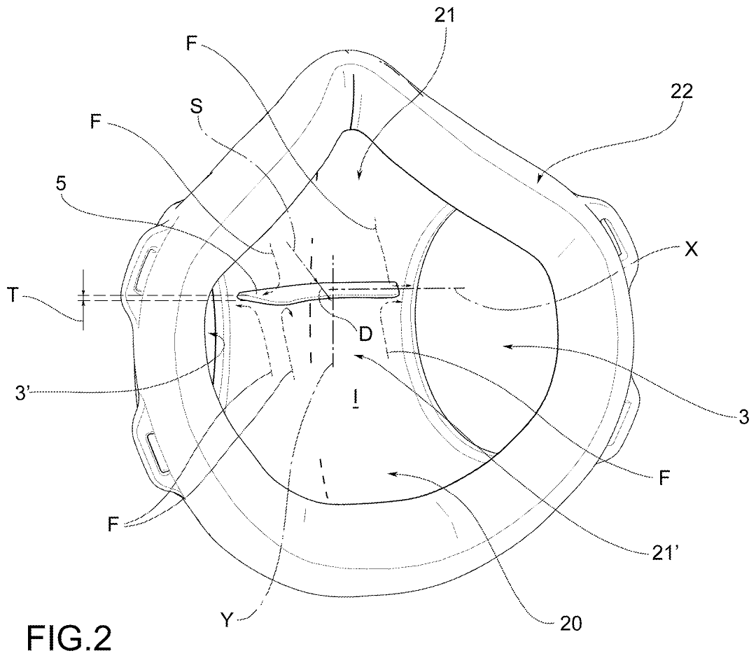

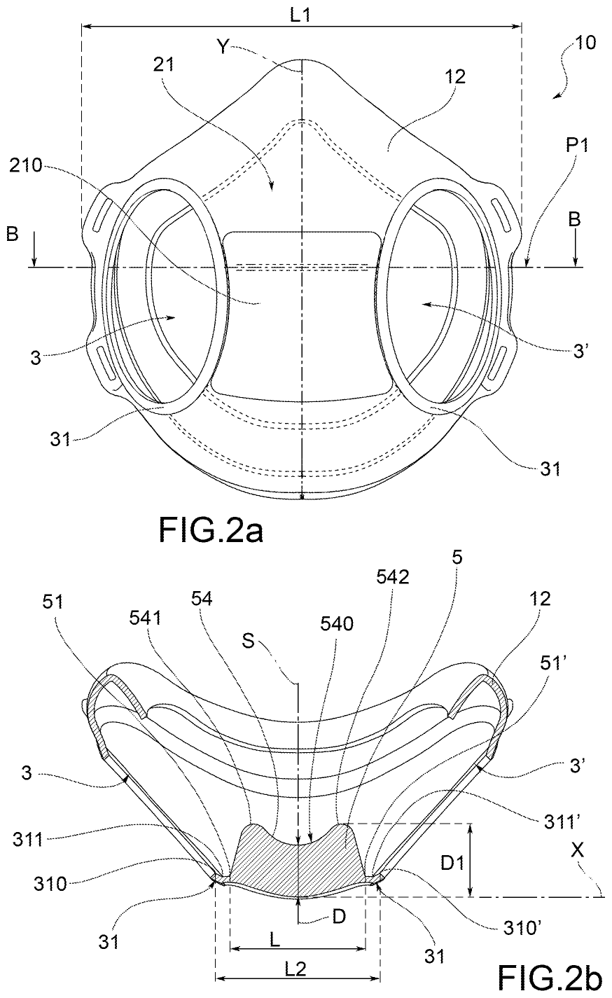

FIG. 2 shows an axonometric view of the personal protective device according to an embodiment of the present invention viewed from its inner side suitable to be in contact with the user's face in which the filtering group has been removed and the air inlet openings are visible;

FIG. 2a shows a front elevation view of the personal protective device according to an embodiment of the present invention viewed from its outer side, wherein the filtering group has been removed and the air inlet openings are visible;

FIG. 2b shows a section plan view of the personal protective device of FIG. 2a along the section plane B-B of FIG. 2a, corresponding to the section plane P1 secant to the deflector wall, described hereinafter in the description;

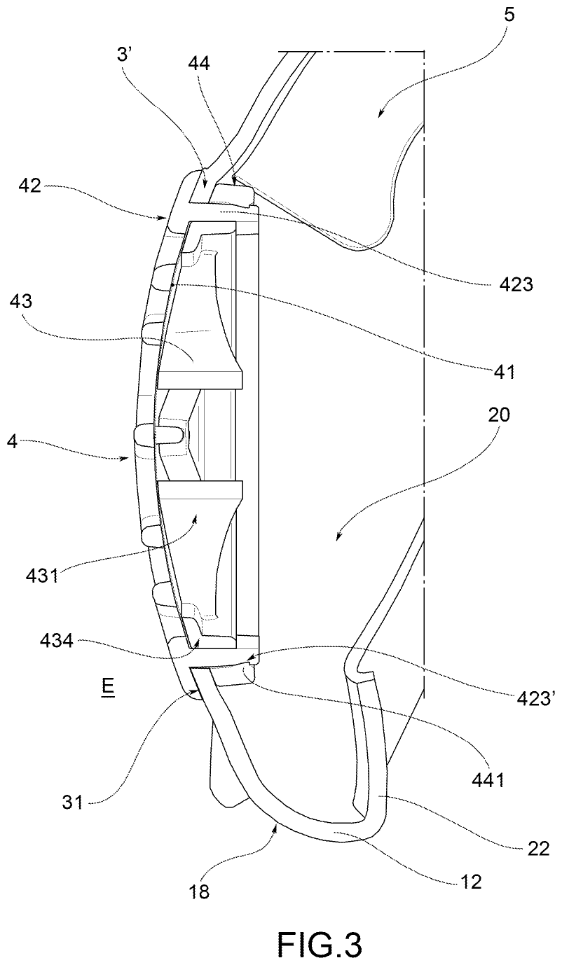

FIG. 3 shows a cross-sectional view along the section plane π of a portion of the personal protective device in FIG. 1 near the filtering group.

With reference to the aforesaid figures, a wearable personal protective device 10 is collectively indicated with the reference number 10.

The personal protective device 10 is classifiable preferably as a face mask.

The personal protective device according to the present invention comprises a protective wall 12 made of a polymeric material, suitable to be placed sealingly on the face of a user to simultaneously cover at least the nose and mouth of the user. The polymeric material of the protective wall 12 is preferably a rigid or semi-rigid plastic, for example acrylonitrile butadiene styrene (ABS) or a rubber or similar material, preferably opaque to visible light.

According to a particularly advantageous embodiment, the protective wall is made at least partially or completely of medical silicone, which is preferably opaque.

According to a further particularly advantageous embodiment, the protective wall is made at least partially or completely of food-grade silicone, which is preferably opaque.

According to another particularly advantageous embodiment, the protective wall is made at least partially or entirely of thermoplastic polyurethane (TPU), which is preferably opaque.

The protective wall 12 comprises an outer side 18 in use facing towards the external environment E and an inner side 20 arranged opposite said outer side 18 and facing, and at least partially defining, an inner cavity I, where the user breathes when in use. The protective wall 12 is suitable for totally preventing the passage of an air flow from the outer side 18 to the inner side 20 and vice versa. In other words, the polymeric material of which the protective wall 12 is made is a compact material and not intended for a filtering action typical of the filtering medium of masks of the prior art (type FFP1, FFP2, FFP3). In other words, the polymeric material of which the protective wall 12 is made is not suitable to allow air to flow through it so that a user may breathe.

The protective wall 12 comprises a central wall portion 21 arranged in front of the user's nose when the personal protective device 10 is worn. Said central wall portion 21 comprises a central inner side 21′ arranged opposite the outer side 18. Said central inner side 21′ is a portion of the inner side 20 of the protective wall 12.

A first inlet opening 3 is obtained in the protective wall 12 and is passed through said protective wall 12 in such a way as to allow the passage of an air flow in and out of the external environment E, as visible for example in FIG. 2.

The personal protective device 10 also comprises a filtering group 4 arranged at said first inlet opening 3 and comprises a filtering medium 41 suitable for filtering the incoming air stream passing therein.

Additionally, the personal protective device 10 comprises a deflector wall 5, which projects from the central inner side 21′ of the central wall portion 21 and extends for a certain depth D from said central inner side 21′ towards the inner cavity I of the personal protective device 10 and along a sagittal direction S incident on the central wall portion 21.

Said deflector wall 5 has an extension along a front direction Y, perpendicular to the sagittal direction S, which is much less than the given depth D. In other words, such a deflector wall 5 has a small thickness T in the front direction Y.

Further, the deflector wall 5 is arranged to divert a flow of exhaled air F from the user's mouth and/or nose to the first inlet opening 3. This allows advantageously to optimize the inner flows, separating the exhalation flows of the nose from the inhalation flows of the mouth, in synergy with the position of the filtering medium. In effect, the exhalation flows are conveyed at the outlet toward the filtering medium 41 and, by taking advantage of the turbulence generated by the movement of the inner flows, help the fresh air volumes to circulate.

Preferably, the deflector wall 5 is arranged on the central wall portion 21 such that it is located between the user's mouth and nose in the front direction Y when the personal protective device 10 is worn. Preferably, the deflector wall 5 extends for a certain depth D such that it does not touch the user's face (neither the nose nor the mouth) when the protective device is worn.

Preferably, as may be unambiguously derived from FIGS. 2 and 2a, the deflector wall 5 divides the inner cavity I into a lower volume below the deflector wall 5 and an upper volume above the deflector wall 5. These lower and upper volumes are communicating with each other. Specifically, the lower volume is arranged in front of the mouth when the protective device is worn, while the upper volume is arranged in front of the nose when the protective device is worn. Preferably, the lower volume is in fluid communication with the upper volume due to the interspace generated between the deflector wall 5 and the face of the user, i.e., the interspace between the deflector wall 5 and the mouth or nose, due to the fact that the deflector wall 5 has a depth D less than the distance between the face (mouth or nose) of the user and the central inner side 21′ of the personal protective device 10 along the sagittal direction S.

According to a preferred variant embodiment, as shown in FIGS. 1 and 2, the personal protective device 10 further comprises a second inlet opening 3′ formed in the protective wall 12, passing through said protective wall 12 and suitable to allow the passage of an air flow in and out of the external environment E.

In this variant, a second filtering group 4′ is arranged at the second inlet opening 3′ comprising a second filtering medium 41′ suitable for filtering the incoming air flow therethrough.

In this variant, the central wall portion 21 is interposed between the first inlet opening 3 and the second inlet opening 3′, and the deflector wall 5 is arranged between the first inlet opening 3 and the second inlet opening 3′. Further, the deflector wall 5 extends predominantly along a coronal direction X perpendicular to the sagittal direction S and front direction Y for a predefined coronal distance L.

The personal protective device 10, and in particular the protective wall 12, extends in width along the coronal direction X for a predefined wall width L1 such as to allow the protective wall 12 to be in contact with the cheeks of the user.

According to variant embodiments, the wall width L1 is for example between 100 and 160 millimeters; preferably it is approximately 136 millimeters. Said wall width L1 is calculated as the distance along the connecting line of two outermost and opposite edges of the protective wall 12, along the coronal direction X, i.e., along a plane perpendicular to the sagittal and front directions Y, as for example shown in FIG. 2b.

Preferably, the deflector wall 5 is shaped such that the ratio of the depth D to the coronal distance L is between 0.2 and 0.5, preferably approximately 0.38.

Preferably, independently or concurrently with the aforesaid ratio of the depth D to the coronal distance L, the deflector wall 5 is shaped such that the ratio of the coronal distance L to the wall width L1 is between 0.2 and 0.4, preferably approximately 0.31.

Preferably, the first 3 and second inlet openings 3′ are arranged symmetrically with respect to the central wall portion 21.

Preferably, the personal protective device 10 comprises an edge portion 22, joined in one piece to the protective wall 12 and forming a flap on the protective wall 12 toward the inner cavity I. Said edge portion 22 is shaped to fit the user's face and to rest sealingly thereon.

According to an advantageous embodiment, the central wall portion 21 comprises at least one transparent region 210, made of a transparent material arranged and shaped to allow the user's mouth to be seen through said transparent region by an external viewer looking at the personal protective device 10 from the external environment E. This allows the external viewer to see the lips of the user wearing the mask.

Preferably, the transparent material of the transparent region 210 is a transparent medical silicone. The choice of this material, in synergy with the deflector wall 5, has surprisingly made it possible to minimize fogging problems in the transparent region 210.

Typically, the protective wall 12 comprises an opening edge portion 31 that delimits the first inlet opening 3 or the second inlet opening 3′.

Preferably, with reference to FIG. 2b, in a plan view along a section plane P1 secant to the deflector wall 5 and parallel to the sagittal direction S and the coronal direction X, shown for example in FIG. 2a, the central wall portion 21 is delimited externally between a first wall edge 310 facing the first inlet opening 3 and a second wall edge 310′ opposite the first and facing the second inlet opening 3′.

The first wall edge 310 delimits the opening edge portion 31 of the first inlet opening 3, and the second wall edge 310′ delimits the opening edge portion 31 of the second inlet opening 3′.

Preferably, with reference to FIG. 2b, in the plan view along a section plane P1 secant to the deflector wall 5 and parallel to the sagittal direction S and the coronal direction X, shown for example in FIG. 2a, the deflector wall 5, in the region joining with the central wall portion 21, is delimited externally between a first deflector edge 51 facing the first inlet opening 3 and a second deflector edge 51′ opposite the first and facing the second inlet opening 3′.

According to an embodiment, the first deflector edge 51 is spaced apart from the first wall edge 310 along the coronal direction X; in other words, there is an intermediate wall portion 311 between the first deflector edge 51 and the first wall edge 310.

According to an embodiment, preferably in conjunction with the embodiment of the preceding paragraph, the second deflector edge 51′ is spaced apart from the second wall edge 310′ along the coronal direction X; in other words, there is an intermediate wall portion 311′ between the second deflector edge 51′ and the second wall edge 310′.

Preferably, the deflector wall 5 is shaped such that the ratio of the coronal distance L to a central portion width L2 between the first wall edge 310 and the second wall edge 310′ is at least equal to or greater than 0.7, preferably greater than 0.8, and even more preferably approximately equal to 0.82. This advantageously allows exhalation flows to be diverted from the mouth and nose adequately and so as to create the turbulence necessary to allow fresh air to be available to the user's mouth and nose.

In this case, the coronal distance L is to be understood as calculated as the distance between the first deflector edge 51 and the second deflector edge 51′ and along the connecting line the first deflector edge 51 and the second deflector edge 51′ on the section plane secant to the deflector wall 5 and parallel to the sagittal direction S and the coronal direction X. Further, the central portion width L2 is to be understood as calculated as the distance between the first wall edge 310 and the second wall edge 310′ and along the connecting line the first wall edge 310 and the second wall edge 310′ on the section plane P1.

According to a particularly advantageous shape, along the section plane P1 secant to the deflector wall 5 and parallel to the sagittal direction S and to the coronal direction X, the deflector wall 5 is shaped in such a way as to have an inner flap 54 shaped so as to have a concave portion 540 facing at a distance towards the nose of the user and delimiting the deflector wall 5 towards the inner side 20. The concave portion 540 is interposed between two opposite convex portions 541, 542, each arranged at one side of the concave portion 540 and defining the innermost limit of extension in the sagittal direction S of the deflector wall 5. Thus, the opposite convex portions 541, 542 of the deflector wall 5 extend internally more than the concave portion 540. This allows for an adequate deflection of exhaled air flows while still ensuring an adequate wearability of the personal protective device, due to the fact that the user's nose does not touch the concave portion 540.

In the aforesaid variant, preferably, the deflector wall 5 is shaped such that the ratio of the depth D to the convex portion depth D1, calculated as the distance from the central inner side 21′ towards the inner cavity I along a sagittal direction S to the innermost point of the convex portion 541, is at least equal to or greater than 0.6, preferably greater than 0.7 and even more preferably approximately equal to 0.71.

According to an embodiment, the deflector wall 5 has an extension along the front direction Y, i.e., an average thickness between 0.5 and 3 millimeters, ends included, and preferably approximately 1 millimeter. Preferably, the cross section of the deflector wall along a section plane parallel to the front direction Y and perpendicular to the coronal direction X, has a trapezoidal or triangular shape with the major base facing the inner central side 21′. Preferably, the thickness at the major base is between 1 and 3 millimeters, preferably approximately 2 millimeters, while the thickness at the vertex of the triangle or the minor base of the trapezoid is between 0.5 and 1.5 millimeters, preferably approximately 1.4 millimeters.

Hereinafter, where technical details of the filtering group 4 are described, said technical details will be understood to be also comprised in the second filtering group 4′ or even only in the second filtering group 4′. In other words, the filtering group 4 and the second filtering group 4′ may be identical to each other.

According to a particularly advantageous embodiment, the filtering group 4 comprises a fixing element 42 comprising a fixing element central region 421 having one or more through openings 421′ for an air flow to pass from/to the inner cavity I. Further, the filtering group 4 comprises also an outer edge portion 422, arranged about the fixing element central region 421 and sealingly and removably engaged to the opening edge portion 31 of the protective wall 12.

The filtering group 4 further comprises a removable element 43, comprising a removable element central region 431 having one or more through openings 431′ for an air flow to pass from/to the inner cavity I, and an interlocking portion 434, removably engaged to the fixing element 42.

The filtering medium 41 is trapped between the fixing element central region 421 and the removable element central region 431, said filtering medium being for example a filtering sheet, preferably of a type suitable for use as a personal protective device or medical device, for example FFP1, FFP2 or FFP3 according to UNI EN 149. Thus, the removal of the filtering medium 41 is only possible after disengaging the removable element 43 from the fixing element 42.

Preferably, the filtering medium 41 is a sheet of filtering material that is not permanently fixed or bonded to either the fixing element or the removable element 43. In other words, the filtering medium 41 ends up locked between the fixing element central region 421 and the removable element central region 431 only due to the “sandwich-type” engagement therebetween.

Preferably, the filtering group 4 comprises an abutment element 44 that is removably engaged with the fixing element 42 and with the opening edge portion 31 on opposite sides of the engagement of the outer edge portion 422. In this way, the opening edge portion 31 is “sandwiched” between the abutment element 44 and the outer edge portion 422. Further, said abutment element 44, being arranged on the inner side 20, prevents the fixing element from escaping from the first 3 or second inlet opening 3′.

According to an embodiment, the abutment element 44 is a ring comprising raised or recessed abutment locking portions 441. Further, the fixing element 42 comprises an annular fixing portion 423 on which raised or recessed fixing portions 423′ are obtained. Said locking abutment portions 441 and said fixing portions 423′ are mutually engaged in a releasable manner for the stable coupling of the abutment element 44 to the fixing element 42. Preferably, said locking abutment portions 441 and said fixing portions 423′ are engaged to each other by snap interference. This allows an easy installation and removal of the filtering group 4, as well as easy replacement of the fixing element 42, so that the arrangement of the through openings 421′, i.e., the outer appearance of the grid formed by the through openings 421′, may be changed as desired.

According to a preferred embodiment, the removable element central region 431 of the removable element 43 comprises one or more elastically deformable walls 432, 433 joined to the interlocking region 434 and suitable to be elastically deformed by an action exerted by the fingers of a user. As a result of elastic deformation of the elastically deformable walls 432, 433, the interlocking region 434 in turn undergoes deformation such that said interlocking region 434 is disengaged from the fixing element 42.

Preferably, the interlocking region 434 engaged by interference with the fixing element 42, as a result of deformation of the elastically deformable walls, varies its taper and/or its circular, elliptical, or ovoid shape so as to disengage from the fixing element.

Preferably, each of the elastically deformable walls 432, 433 is shaped substantially to a semi-annular shape and is joined in one piece to the interlocking region 434 such that a gripping space P is defined internally to the semi-annular shape and delimited by the elastically deformable wall 432, 433 and the interlocking region 434. The gripping space P is suitable to accommodate a finger of a user's hand whereby the user may exert an action on each of the elastically deformable walls 432, 433 so as to induce deformation at least at the points of union with the interlocking region 434.

It is understood that the subject of the present invention is also the filtering group 4, 4′ per se, as described above, and in particular comprising at least:
the fixing element 42 having the outer edge portion 422 adapted to engage sealingly and removably with the opening edge portion 31 of the protective wall 12;
the removable element 43, having the interlocking portion 434 adapted to engage removably with the fixing element 42.

As described above, between the fixing element central region 421 and the removable element central region 431, the filtering medium 41 is adapted to be trapped, such that removal of the filtering medium 41 requires disengaging the removable element 43 from the fixing element 42.

Innovatively, the present invention successfully overcomes the cited drawbacks with respect to personal protective devices of the prior art.

In particular, the present invention enables optimization of internal inhalation and exhalation flows, due to the internal positioning of the deflector wall, which is able to separate exhalation flows of the nose from inhalation flows of the mouth in synergy with the position of the filtering medium.

Advantageously, with this device it is possible to direct the outgoing exhalation flows towards the filtering material and, exploiting the turbulence generated by the movement of the internal flows, aid the circulation of fresh air volumes and thus improve breathing comfort.

Synergistically, moreover, the deflector wall allows the creation of condensation on the transparent portion of the protective device to be significantly reduced, making the wearer's lips visible at all times.

Furthermore, due to the presence of a deflector wall that is not in contact with the user's face, adequate mask comfort, and adequate circulation of exhalation and inhalation flows are ensured, with a reduced risk of increased carbon dioxide concentration.

Additionally, the use of medical silicone for the protective wall 12 allows for a biocompatible device to be obtained, that is hypoallergenic, sterilizable, and with high mechanical and thermal resistance.

Additionally, medical grade silicone provides better resistance over time to weathering, UV-A rays, and the temperature range of −40° C. to +250° C.

In addition, the interference coupling obtained in the elements of the filtering group ensures the maximum seal regardless of the thickness of the filtering medium used and also allows for easy and rapid replacement of the filtering medium.

Additionally, the presence of the raised or recessed abutment locking portions and the respective fixing portions 423′ always allows for proper mounting and an adequate seal, regardless of the operator.

A person skilled in the art may, in order to meet specific needs, make several changes to the embodiments of this invention or substitutions of elements with other functionally equivalent ones.

These variants are also contained within the scope of protection as defined by the following claims.

What is claimed is:

1. A wearable personal protective device comprising:
a protective wall made of polymeric material, suitable to be sealingly placed on a user's face to simultaneously cover at least his/her nose and mouth, and comprising an outer side facing, in use, an external environment and an inner side arranged opposite to said outer side and facing and at least partially defining an inner cavity, said protective wall being suitable to totally prevent passage of an air flow from the outer side to the inner side and vice versa;
wherein the protective wall comprises a central wall portion, arranged in front of the user's nose when the wearable personal protective device is worn, said central wall portion comprising a central inner side arranged opposite to the outer side;
a first inlet opening formed in the protective wall, passing through said protective wall and suitable to allow passage of an air inflow/outflow from/towards the external environment;
a filtering group arranged at said first inlet opening comprising a filtering medium suitable to filter the air inflow passing therethrough;
wherein the protective wall comprises an opening edge portion delimiting the first inlet opening,
wherein the filtering group comprises:
a fixing element comprising a central fixing element region provided with one or more through openings for passage of an air flow from/towards the inner cavity, an outer edge portion, arranged around the central fixing element region, sealingly and removably engaged with the opening edge portion of the protective wall; and
a removable element, comprising a central removable element region provided with one or more through openings for the passage of the air flow from/towards the inner cavity, and an interlocking portion, removably engaged with the fixing element; and
wherein the filtering medium is trapped between the central fixing element region and the central removable element region, so that the removable element needs to be disengaged from the fixing element for removing the filtering medium.

2. The wearable personal protective device of claim 1, further comprising a second inlet opening formed in the protective wall, passing through said protective wall and suitable to allow the passage of the air inflow/outflow from/towards the external environment, and a second filtering group equal to the first filtering group, arranged at said second inlet opening and comprising a second filtering medium adapted to filter the air inflow passing therethrough, wherein the central wall portion is interposed between the first inlet opening and the second inlet opening.

3. The wearable personal protective device of claim 1, wherein the filtering medium is a sheet of filtering material which is not permanently fixed or glued to either the fixing element or the removable element, being locked between the central fixing element region and the central removable element region only by sandwich engagement.

4. The wearable personal protective device of claim 1, wherein the filtering group and/or the second filtering group comprises an abutment element removably engaged with the fixing element and with the opening edge portion on an opposite side with respect to an engagement of the outer edge portion, so that the opening edge portion is interposed in a sandwich-like manner between the abutment element and the outer edge portion said abutment element being suitable to prevent an escape of the fixing element from the first inlet opening or the second inlet opening.

5. The wearable personal protective device of claim 4, wherein the abutment element is a ring comprising raised or recessed abutment locking portions, and wherein the fixing element comprises an annular fixing portion on which raised or recessed fixing portions are formed, said raised or recessed abutment locking portions and said raised or recessed fixing portions being mutually engaged in a releasable manner for stable coupling of the abutment element to the fixing element.

6. The wearable personal protective device of claim 1, wherein the central removable element region of the removable element comprises one or more elastically deformable walls, joined to the interlocking portion and suitable to be elastically deformed by an action exerted by the user's fingers, so that as a consequence of an elastic deformation of the elastically deformable walls, the interlocking portion in turn undergoes a deformation such as to disengage said interlocking portion from the fixing element.

7. The wearable personal protective device of claim 6, wherein each of the elastically deformable walls is shaped in a semi-annular shape and is joined in one piece to the interlocking portion so that a gripping space is defined inside the semi-annular shape and delimited by the elastically deformable walls and by the interlocking portion, said gripping space being suitable to accommodate a finger of a user's hand so that the user can exert an action on each of the elastically deformable walls to cause a deformation at least at joining points with the interlocking portion.

8. The wearable personal protective device of claim 1, further comprising a deflector wall, projecting from the central inner side of the central wall portion and extending over a certain depth from said central inner side towards the inner cavity of the wearable personal protective device and along a sagittal direction incident on the central wall portion, wherein said deflector wall has an extension along a front direction perpendicular to the sagittal direction much smaller than the certain depth, the deflector wall having a small thickness in the front direction and being arranged so as to divert an exhaled air flow from the user's mouth and/or nose towards the first inlet opening.

9. The wearable personal protective device claim 2, further comprising a deflector wall projecting from the central inner side of the central wall portion and extending over a certain depth from said central inner side towards the inner cavity of the wearable personal protective device and along a sagittal direction incident on the central wall portion, wherein said deflector wall has an extension along a front direction perpendicular to the sagittal direction much smaller than the certain depth, the deflector wall having a small thickness in the front direction and being arranged so as to divert an exhaled air flow from the user's mouth and/or nose towards the first inlet opening, and wherein the deflector wall is arranged between the first inlet opening and the second inlet opening and mainly extends along a coronal direction perpendicular to the sagittal direction and the front direction.

10. The wearable personal protective device of claim 1, further comprising an edge portion, joined in one piece to the protective wall and forming a flap of the protective wall towards the inner cavity.

11. The wearable personal protective device of claim 1, wherein the central wall portion comprises at least one transparent region, made of a transparent material, arranged and shaped to allow the user's mouth to be seen through said transparent region by an external viewer looking at the wearable personal protective device from the external environment.

12. The wearable personal protective device of claim 11, wherein the transparent material of the transparent region is transparent medical silicone.

13. The wearable personal protective device of claim 1, wherein the protective wall is made at least partially or totally of medical silicone.

14. A filtering group for a wearable personal protective device according to claim 1, comprising an opening edge portion delimiting the first inlet opening or a second inlet opening, said filtering group comprising:
a fixing element comprising a central fixing element region provided with one or more through openings for the passage of an air flow from/towards the inner cavity, an outer edge portion, arranged around the central fixing element region, suitable to sealingly and removably engage the opening edge portion of the protective wall; and
a removable element, comprising a central removable element region provided with one or more through openings for the air flow to pass from/towards the inner cavity, and an interlocking portion, suitable to removably engage the fixing element;
wherein the filtering medium is suitable to remain trapped between the central fixing element region and the central removable element region, so that the removable element needs to be disengaged from the fixing element for removing the filtering medium.
